(19) United States
(12) Patent Application Publication
(10) Pub. No.: US 2006/0019122 A1
(43) Pub. Date: Jan. 26, 2006

(54) Recording medium substrate and recording medium having an electroless plating film with a good film quality

(75) Inventors: Hiroyasu Kawano, Kawasaki (JP); Takahiro Umada, Kawasaki (JP); Mineo Moribe, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMTED

(21) Appl. No.: 10/991,773

(22) Filed: Nov. 18, 2004

(30) Foreign Application Priority Data
Jul. 20, 2004 (JP) 2004-211350

(51) Int. Cl. G11B 5/66; G11B 5/65

(52) U.S. Cl. 428/827; 428/836.1

(57) ABSTRACT

A recording medium substrate has on a surface thereof a foundation film for electroless plating film formation, or has such a foundation film and an electroless plating film formed thereon. The foundation film includes an alloy containing one metallic element selected from Co and Cu, and an element having a greater ionization tendency than the metallic element. A recording medium may be manufactured, for example, using such a recording medium substrate.

### BACKGROUND OF THE INVENTION

1. Field of the Invention

The present invention relates to a substrate that can be used for a recording medium such as a magnetic disk or an optical disk, and to a recording medium such as a magnetic disk or an optical disk.

2. Description of the Related Art

With magnetic disks and optical magnetic disks, to improve recording characteristics, an applied magnetic field enhancing layer comprising a soft magnetic material may be provided close to a recording layer. Moreover, with optical disks, to improve playback characteristics, a reflective layer having a good metallic luster may be provided close to a recording layer. Electroless plating maybe used as the method of forming such an applied magnetic field enhancing layer or reflective layer. Art for forming an applied magnetic field enhancing layer by electroless plating is described, for example, in Japanese Patent Application Laid-open No. 6-243456 and Japanese Patent Application Laid-open No. 2004-152367.

When forming an applied magnetic field enhancing layer or reflective layer by electroless plating, for example, first a substrate on which this layer is to be formed is immersed in a prescribed acidic aqueous solution, thus cleaning the substrate surface that will be the base end of the plating growth (acid cleaning treatment). This cleaning is carried out to remove a contaminant film such as an oxide film from the substrate surface so as to expose a new surface onto which a catalyst described below will be readily adsorbed. Next, after washing with water, the substrate is immersed in, for example, a palladium chloride aqueous solution (catalyst treatment). The palladium contained in this aqueous solution is adsorbed onto the substrate surface, and functions as a catalyst during the start of the subsequent plating growth. Next, after washing with water, the substrate is immersed in a plating liquid (plating bath). As a result, an electroless plating film grows on the substrate surface, with the palladium on the substrate surface acting as catalytic nuclei. The plating liquid has a prescribed composition in accordance with the composition of the electroless plating film to be formed. In this way, an electroless plating film is formed, for example, as an applied magnetic field enhancing layer or a reflective layer.

With such an electroless plating method, the size of the catalytic nuclei adsorbed on the substrate surface after the catalyst treatment and the distribution of the catalytic nuclei greatly affect the quality of the electroless plating film; a state in which catalytic nuclei of a minute and uniform size are distributed at high density and uniformly over the substrate surface is ideal. However, according to the prior art, depending on the type of the material constituting the substrate and the chemical state of the surface thereof, it may not be possible to remove the contaminant film sufficiently in the acid cleaning treatment, and in this case, during the catalyst treatment, catalytic nuclei will not be readily adsorbed at places where the contaminant film remains, and hence an inappropriate unevenness will arise in the distribution of the catalytic nuclei on the substrate surface.

If the electroless plating film is grown on the substrate surface in a state in which there is inappropriate unevenness in the distribution of the catalytic nuclei on the substrate surface, then preferential growth of the plating particles constituting the electroless plating film will arise in places, i.e. coarse plating particles will be formed, and hence uniform plating growth will be hampered. Loss of uniformity in the plating growth will lead to roughness of the growth end face of the electroless plating film, and a drop in the film density of the electroless plating film. In this way, in the case that the contaminant film is not sufficiently removed through the acid cleaning treatment, the film quality will become poor. This poorness of the film quality is undesirable, since the electroless plating film (applied magnetic field enhancing layer, reflective layer or the like) that is provided on the recording medium to fulfil a prescribed function will be hampered from displaying this function effectively, and this may cause poor recording characteristics or poor playback characteristics of the recording medium.

### SUMMARY OF THE INVENTION

The present invention has been conceived under the above-described circumstances.

It is therefore an object of the present invention to provide a recording medium substrate on which can be formed an electroless plating film having a good film quality.

Another object of the present invention is to provide a recording medium substrate having an electroless plating film with a good film quality.

Another object of the present invention is to provide a recording medium having an electroless plating film with a good film quality.

According to a first aspect of the present invention, there is provided a recording medium substrate having a foundation film (or under-layer) for electroless plating film formation on a surface thereof. The foundation film of this recording medium substrate comprises an alloy containing one metallic element selected from Co and Cu, and an element having a greater ionization tendency than the metallic element. The recording medium substrate is a substrate for constituting part of a recording medium such as a magnetic disk or an optical disk, and the foundation film of the recording medium substrate is a film that functions as a foundation when forming on the recording medium substrate an electroless plating film that is provided on the recording medium to fulfil a prescribed function.

When forming the electroless plating film by electroless plating on the recording medium substrate, first an acidic aqueous solution is made to act on the surface of the foundation film which will have become chemically disuniform due to a contaminant film such as an oxide film having been formed thereon (acid cleaning treatment). The foundation film comprises an alloy containing Co and an element having a greater ionization tendency than Co (i.e. an element that is electrochemically baser than Co), or an alloy containing Cu and an element having a greater ionization tendency than Cu (i.e. an element that is electrochemically baser than Cu). As a result, in the acid cleaning treatment, a local cell reaction occurs at each place on the surface of the basis material (the chemically uncontaminated structure) of the foundation film, and the base element (the element having a greater ionization tendency than Co or Cu) contained in the basis material dissolves in the acidic aqueous solution, and hence dissolution of the whole of the surface of the basis material of the foundation film, which is an alloy, is promoted. Consequently, in the acid cleaning treatment, in addition to the direct dissolving action on the contaminant film by the acidic aqueous solution, due also to dissolution at the surface of the basis material of the foundation film through the local cell reactions, the whole of the foundation film surface is uniformly dissolved instantaneously, and hence a new foundation film surface on which the contaminant film does not remain at all or hardly remains is exposed. Moreover, the Co or Cu contained in the foundation film has a relatively low ionization tendency (i.e. is electrochemically relatively noble), and hence is not readily dissolved by the acidic aqueous solution used in the acid cleaning treatment. Here, Cu has a lower ionization tendency than Co, and hence is even less readily dissolved. In contrast, for example Fe(II), which has a greater ionization tendency than Co, is readily dissolved by the acidic aqueous solution used in the acid cleaning treatment. Consequently, if the acidic aqueous solution in the acid cleaning treatment were made to act on a film comprising, for example, an alloy containing Fe(II) and an element having a greater ionization tendency than Fe(II), then many pinhole defects may be produced in the Fe alloy film. In this way, a film of an alloy comprising an element such as Fe(II) having a greater ionization tendency than Co, and an element having a yet greater ionization tendency than this is unsuitable as a foundation film for electroless plating film formation.

In the formation of the electroless plating film on the recording medium substrate, next, after washing with water, a catalyst solution is made to act on the surface of the foundation film, thus adsorbing catalytic nuclei (e.g. palladium) onto the surface of the foundation film (catalyst treatment). At this time, because the contaminant film does not remain at all or hardly remains on the surface of the foundation film, inappropriate unevenness does not arise in the distribution of the catalytic nuclei on the surface of the foundation film, and moreover the catalytic nuclei are adsorbed at a sufficient density at each place on the surface of the foundation film. Next, after washing with water, an electroless plating liquid of a prescribed composition is made to act on the surface of the foundation film, thus growing an electroless plating film on the foundation film, with the catalytic nuclei adsorbed on the surface of the foundation film acting as base points. At this time, because there is no inappropriate unevenness in the distribution of the catalytic nuclei on the surface of the foundation film, preferential growth in places of the plating particles constituting the electroless plating film is suppressed, and hence the electroless plating film grows homogeneously over the whole thereof. Moreover, because the catalytic nuclei are adsorbed at a sufficient density a teach place on the surface of the foundation film, the electroless plating film grows finely. Consequently, an electroless plating film for which roughness of the growth end face is suppressed, and moreover a drop in the film density is suppressed, i.e. an electroless plating film having a good film quality, is formed.

In this way, an electroless plating film having a good film quality can be formed on the recording medium substrate of the first aspect of the present invention. The better the film quality of the electroless plating film, the more effectively the prescribed function of the electroless plating film can be displayed, which is preferable in terms of improving the recording characteristics and playback characteristics of the recording medium.

According to a second aspect of the present invention, there is provided a recording medium substrate having a foundation film, and an electroless plating film formed on the foundation film. The foundation film of this recording medium substrate comprises an alloy containing one metallic element selected from Co and Cu, and an element having a greater ionization tendency than the metallic element. This recording medium substrate is manufactured by forming an electroless plating film as described above on the recording medium substrate of the first aspect of the present invention. The electroless plating film of the recording medium substrate thus has a good film quality.

According to a third aspect of the present invention, there is provided a recording medium having a layered structure comprising a foundation film, an electroless plating film formed on the foundation film, and a recording layer. The foundation film of this recording medium comprises an alloy containing one metallic element selected from Co and Cu, and an element having a greater ionization tendency than the metallic element. This recording medium is manufactured by forming an electroless plating film as described above on the recording medium substrate of the first aspect of the present invention, and then further forming a prescribed recording layer. The electroless plating film of this recording medium thus has a good film quality.

In the first to third aspects of the present invention, preferably, the content of the metallic element (Co or Cu) in the alloy of the foundation film is at least 50 at % but less than 100 at %. The content of the Co or Cu is preferably in such a range as to produce suitable local cell reactions in the foundation film during the acid cleaning treatment, while still securing the resistance of the foundation film to the acidic aqueous solution used in the acid cleaning treatment.

According to a fourth aspect of the present invention, there is provided a recording medium substrate having a foundation film for electroless plating film formation on a surface thereof. The foundation film of this recording medium substrate comprises a first layer, and a second layer that covers the first layer and is exposed at the surface. The first layer comprises an alloy containing a metallic element selected from the group consisting of Ni, Co and Cu, and a non-metallic element selected from the group consisting of P, B, C and S. The second layer comprises an alloy containing one metallic element selected from the group consisting of Ni, Co and Cu, and an element having a greater ionization tendency than the metallic element. The recording medium substrate is a substrate for constituting part of a recording medium such as a magnetic disk or an optical disk, and the foundation film of the recording medium substrate is a film that functions as a foundation when forming on the recording medium substrate an electroless plating film that is provided on the recording medium to fulfil a prescribed function. Moreover, when forming the electroless plating film by electroless plating on the recording medium substrate, as described earlier with regard to the recording medium substrate of the first aspect of the present invention, the electroless plating film is grown on the foundation film after carrying out acid cleaning treatment and catalyst treatment. In the acid cleaning treatment, as with the local cell reactions occurring at the surface of the foundation film in the recording medium substrate of the first aspect of the present invention, local cell reactions occur at the surface of the foundation film or the second layer, and hence the whole of the foundation film surface is uniformly dissolved instantaneously, and hence a new foundation film surface on which a contaminant film does not remain at all or hardly remains is exposed.

The first layer in the foundation film of this recording medium substrate comprises an alloy selected from the group consisting of NiP, NiB, NiC, NiS, CoP, CoB, CoC, CoS, CuP, CuB, CuC and CuS; these alloys have a considerably high resistance to the acidic aqueous solution in the acid cleaning treatment. Consequently, in the acid cleaning treatment, even if pinhole defects should happen to arise in the second layer which has a relatively high activity to the acidic aqueous solution, then even if pinholes that penetrate through the second layer in the thickness direction thereof are formed, parts of the first layer exposed by these pinholes will substantially not be dissolved by the acidic aqueous solution. As a result, in the catalyst treatment, catalytic nuclei can be adsorbed onto the surface of the first layer at places facing out onto the pinholes, and hence inappropriate unevenness will not arise in the distribution of the catalytic nuclei over the surface of the foundation film as a whole, and moreover the catalytic nuclei will be adsorbed at a sufficient density a teach place on the surface of the foundation film. Because inappropriate unevenness does not arise in the distribution of the catalytic nuclei on the surface of the foundation film after the catalyst treatment, and moreover the catalytic nuclei are adsorbed at a sufficient density at each place on the surface of the foundation film, an electroless plating film will grow homogeneously and finely on the foundation film. Consequently, an electroless plating film for which roughness of the growth end face is suppressed, and moreover a drop in the film density is suppressed, i.e. an electroless plating film having a good film quality, is formed. In this way, an electroless plating film having a good film quality can be formed on the recording medium substrate of the fourth aspect of the present invention.

According to a fifth aspect of the present invention, there is provided a recording medium substrate having a foundation film, and an electroless plating film formed on the foundation film. The foundation film of this recording medium substrate comprises a first layer, and a second layer on the first layer. The first layer comprises an alloy containing a metallic element selected from the group consisting of Ni, Co and Cu, and a non-metallic element selected from the group consisting of P, B, C and S. The second layer comprises an alloy containing one metallic element selected from the group consisting of Ni, Co and Cu, and an element having a greater ionization tendency than the metallic element. This recording medium substrate is manufactured by forming an electroless plating film on the recording medium substrate of the fourth aspect of the present invention. The electroless plating film of this recording medium substrate thus has a good film quality.

According to a sixth aspect of the present invention, there is provided a recording medium having a layered structure comprising a foundation film, an electroless plating film formed on the foundation film, and a recording layer. The foundation film of this recording medium comprises a first layer, and a second layer on the first layer. The first layer comprises an alloy containing a metallic element selected from the group consisting of Ni, Co and Cu, and a non-metallic element selected from the group consisting of P, B, C and S. The second layer comprises an alloy containing one metallic element selected from the group consisting of Ni, Co and Cu, and an element having a greater ionization tendency than the metallic element. This recording medium is manufactured by forming an electroless plating film on the recording medium substrate of the fourth aspect of the present invention, and then further forming a prescribed recording layer. The electroless plating film of this recording medium thus has a good film quality.

In the fourth to sixth aspects of the present invention, preferably, the content of the metallic element in the alloy of the second layer is at least 50 at % but less than 100 at %. The content of the Ni, Co or Cu is preferably in such a range so as to produce suitable local cell reactions in the foundation film during the acid cleaning treatment, while still securing the resistance of the foundation film to the acidic aqueous solution used in the acid cleaning treatment.

### BRIEF DESCRIPTION OF THE DRAWINGS

FIG. 1 shows a cross section of part of a recording medium substrate according to a first embodiment of the present invention.

FIG. 2 shows an example of an ionization series showing ionization tendencies.

FIG. 3 shows the layered structure of a magnetic disk manufactured using the recording medium substrate of FIG. 1.

FIG. 4 shows a cross section of part of a recording medium substrate according to a second embodiment of the present invention.

FIG. 5 shows the layered structure of an optical magnetic disk manufactured using the recording medium substrate of FIG. 4.

### DESCRIPTION OF THE PREFERRED EMBODIMENTS

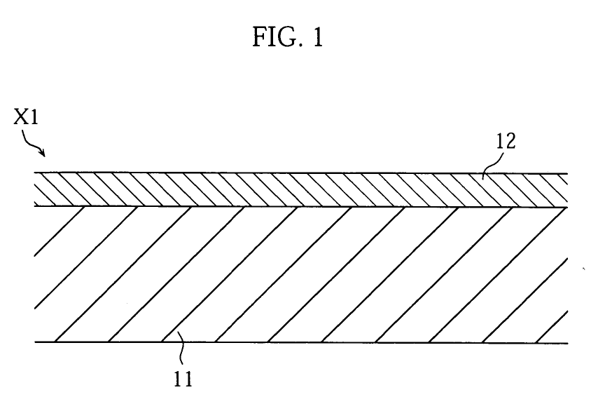

FIG. 1 shows a cross section of part of a recording medium substrate X1 according to a first embodiment of the present invention. The recording medium substrate X1 has a substrate 11 and a foundation film 12, and is constituted as a disk substrate that can be used in the manufacture of a recording medium such as a magnetic disk or an optical disk.

The substrate 11 is a section for securing the rigidity of the recording medium, and is, for example, an aluminum alloy substrate, a silicon substrate, a glass substrate, or a resin substrate.

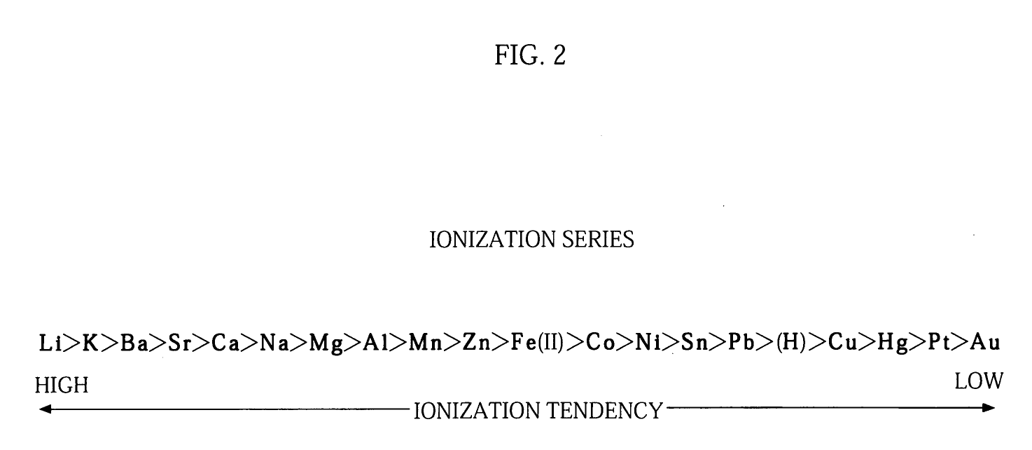

The foundation film 12 is a section that functions as a foundation when forming an electroless plating film on the recording medium substrate X1, and comprises an alloy containing one metallic element selected from Co and Cu, and an element having a greater ionization tendency than this metallic element. For example, the foundation film 12 comprises a CoFe alloy, a CuNi alloy or the like. As shown in FIG. 2, Fe(II) has a greater ionization tendency than Co, and hence is electrochemically baser than Co, and Ni has a greater ionization tendency than Cu, and hence is electrochemically baser than Cu. Moreover, the content of the Co or Cu in the alloy constituting the foundation film 12 is preferably at least 50 at % but less than 100 at %.

The foundation film 12 can be formed on the substrate 11 by, for example, sputtering. To obtain good adhesion between the substrate 11 and the foundation film 12, a bonding layer (omitted from the drawings) may be provided between the substrate 11 and the foundation film 12. In the case of using Cu as the primary material of the alloy constituting the foundation film 12, for example Ti can be used as the material constituting such a bonding layer.

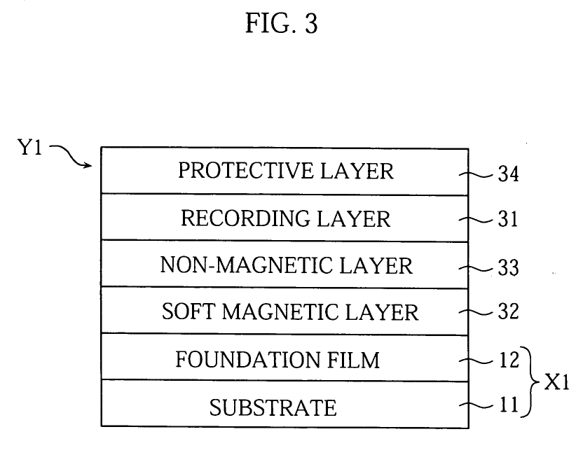

FIG. 3 shows the layered structure of a magnetic disk Y1, which is an example of a recording medium manufactured using the recording medium substrate X1. The magnetic disk Yl has a layered structure comprising the recording medium substrate X1, a recording layer 31, a soft magnetic layer 32, a non-magnetic layer 33, and a protective layer 34, and is constituted as a perpendicular magnetic recording type magnetic disk.

The recording layer 31 is a perpendicularly magnetized film having an axis of easy magnetization that is perpendicular to the plane of the magnetic film constituting this layer, and is a section in which information is recorded. The recording layer 31 comprises, for example, TbFeCo or CoCrPt—SiO₂ having a prescribed composition.

The soft magnetic layer 32 is an applied magnetic field enhancing layer for improving the net recording sensitivity of the recording layer 31 by increasing the magnetic flux density of a magnetic field applied to the recording layer 31 during recording to the magnetic disk Y1, and comprises a soft magnetic plating film formed by electroless plating as described below. The soft magnetic material for constituting the soft magnetic layer 32 is a material having a high saturation magnetization and a low coercivity; as this soft magnetic material, for example FeCoNi, FeNi or CoNi can be used. The thickness of the soft magnetic layer 32 is, for example, 0.5 to 1 μm.

The non-magnetic layer 33 is for magnetically isolating the recording layer 31 and the soft magnetic layer 32 from one another, and moreover preventing influence of the crystal lattice structure of the soft magnetic layer 32 when forming the recording layer 31. The non-magnetic layer 33 comprises a non-magnetic material such as Si, C, NiP or the like.

The protective layer 34 is for physically and chemically protecting the recording layer 31 from the outside world, and comprises, for example, SiN, SiO₂, or diamond-like carbon.

In the magnetic disk Y1, because there is a soft magnetic layer 32 having a high saturation magnetization and a low coercivity close to the recording layer 31, during recording the magnetic flux of a recording magnetic field applied to the recording layer 31 from a magnetic recording head does not spread out but rather is concentrated. The net recording magnetic field applied to the recording layer 31 by the magnetic recording head is thus larger than in the case that such a soft magnetic layer 32 is not present. The larger the net recording magnetic field, the higher the coercivity of the recording layer 31 for which magnetic recording is possible; through increasing the set coercivity of the recording layer 31, the thermal stability of magnetic recording marks formed on the recording layer 31 is improved. The increase in the net recording magnetic field due to the presence of the soft magnetic layer 32 is thus important in realizing a perpendicular magnetic recording type magnetic disk having a recording layer having a high coercivity.

In the manufacture of the magnetic disk Y1, the soft magnetic layer 32 (soft magnetic plating film) is formed on the recording medium substrate X1 by electroless plating, and then the non-magnetic layer 33, the recording layer 31 and the protective layer 34 are formed in this order on the soft magnetic layer 32 by, for example, sputtering.

In the formation of the soft magnetic layer 32 on the recording medium substrate X1, first the recording medium substrate X1 is immersed in an acidic aqueous solution, thus carrying out acid cleaning treatment on the surface of the foundation film 12 which will have become chemically disuniform due to a contaminant film such as an oxide film having been formed thereon. As the acidic aqueous solution, for example hydrochloric acid, nitric acid or sulfuric acid of a prescribed concentration can be used.

Because the foundation film 12 comprises an alloy containing Co and an element that is baser than Co, or Cu and an element that is baser than Cu, in the acid cleaning treatment, a local cell reaction occurs at each place on the surface of the basis material (the chemically uncontaminated structure) of the foundation film 12, and the base element (the element having a greater ionization tendency than Co or Cu) contained in the basis material dissolves in the acidic aqueous solution, and hence dissolution of the whole of the surface of the basis material, which is an alloy, is promoted. Consequently, in the acid cleaning treatment, in addition to the direct dissolving action on the contaminant film by the acidic aqueous solution, due also to dissolution at the surface of the basis material of the foundation film through the local cell reactions, the whole of the surface of the foundation film 12 is uniformly dissolved instantaneously, and hence on the foundation film 12, a new surface on which the contaminant film does not remain at all or hardly remains is exposed. To produce suitable local cell reactions in the foundation film 12 during the acid cleaning treatment while still securing the resistance of the foundation film 12 to the acidic aqueous solution, the content of the Co or Cu in the alloy constituting the foundation film 12 is preferably at least 50 at % but less than 100 at % as described earlier. Moreover, the Co or Cu contained in the foundation film 12 has a relatively low ionization tendency (i.e. is electrochemically relatively noble), and hence is less readily dissolved by the acidic aqueous solution used in the acid cleaning treatment than, for example, Fe(II) (which has a greater ionization tendency than Co or Cu).

In the formation of the soft magnetic layer 32, next, after washing the recording medium substrate X1 with water, the recording medium substrate X1 is immersed in a catalyst solution, thus making the catalyst solution act on the surface of the foundation film 12 and hence adsorbing catalytic nuclei onto the surface of the foundation film 12. As the catalyst solution, for example a palladium chloride aqueous solution or a palladium nitrate aqueous solution of a prescribed concentration can be used. Because the contaminant film does not remain at all or hardly remains on the surface of the foundation film 12, inappropriate unevenness does not arise in the distribution of the catalytic nuclei on the surface of the foundation film 12, and moreover the catalytic nuclei are adsorbed at a sufficient density at each place on the surface of the foundation film 12.

Next, after washing the recording medium substrate X1 with water, the recording medium substrate X1 is immersed in an electroless plating liquid, thus making the electroless plating liquid act on the surface of the foundation film 12 and hence growing a soft magnetic plating film on the foundation film 12, with the catalytic nuclei acting as base points. The electroless plating liquid has a composition in accordance with the soft magnetic material for constituting the soft magnetic layer 32. In the present step, because there is no inappropriate unevenness in the distribution of the catalytic nuclei on the surface of the foundation film 12, preferential growth in places of the plating particles constituting the soft magnetic plating film is suppressed, and hence the soft magnetic plating film grows homogeneously over the whole thereof. Moreover, because the catalytic nuclei are adsorbed at a sufficient density at each place on the surface of the foundation film 12, the soft magnetic plating film grows finely. Consequently, a soft magnetic layer 32 for which roughness of the growth end face is suppressed, and moreover a drop in the film density is suppressed, i.e. a soft magnetic layer 32 having a good film quality, is formed.

In this way, a soft magnetic layer 32 (electroless plating film) having a good film quality can be formed on the recording medium substrate X1. The better the film quality of the soft magnetic layer 32, the more effectively the applied magnetic field enhancing function of the soft magnetic layer 32 can be displayed, which is preferable in terms of improving the recording characteristics of the magnetic disk Y1.

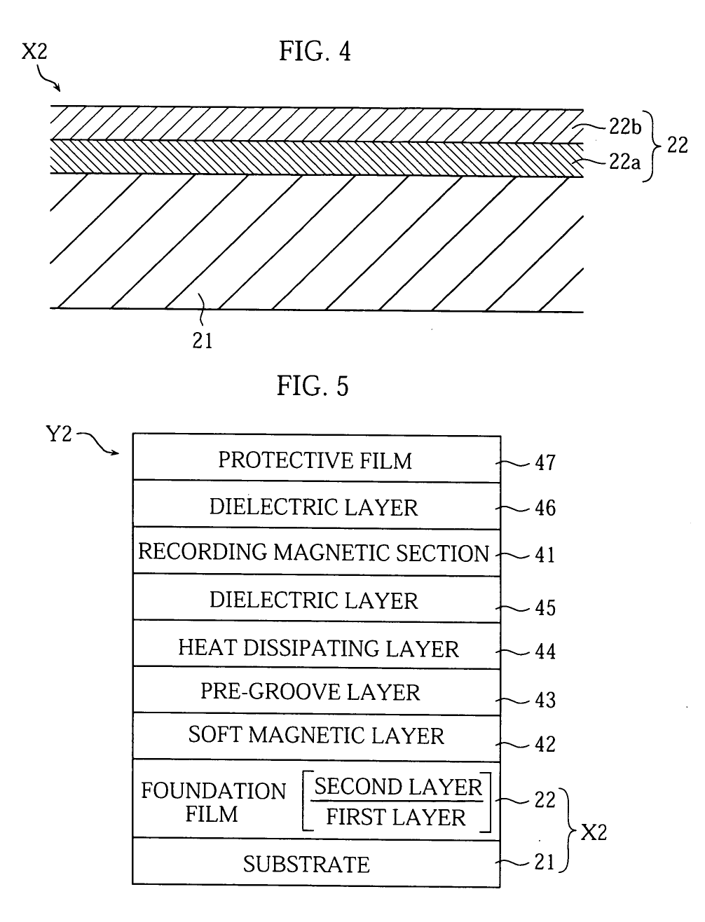

FIG. 4 shows a cross section of part of a recording medium substrate X2 according to a second embodiment of the present invention. The recording medium substrate X2 has a substrate 21 and a foundation film 22 (or under-layer), and is constituted as a disk substrate that can be used in the manufacture of a recording medium such as a magnetic disk or an optical disk.

The substrate 21 is a section for securing the rigidity of the recording medium, and is, for example, an aluminum alloy substrate, a silicon substrate, a glass substrate, or a resin substrate. The foundation film 22 is a section that functions as a foundation when forming an electroless plating film on the recording medium substrate X2, and comprises a first layer 22a and a second layer 22b.

The first layer 22a comprises an alloy containing a metallic element selected from the group consisting of Ni, Co and Cu, and a non-metallic element selected from the group consisting of P, B, C and S. For example, the first layer 22a comprises an NiP alloy, a CoB alloy or the like. Moreover, the content of the metallic element (Ni, Co or Cu) in the first layer 22a is preferably 60 to 95 at %. That is, the content of the non-metallic element (P, B, C or S) in the first layer 22a is preferably 5 to 40 at %. If the content of the non-metallic element is less than 5 at %, then the first layer 22a will tend not to have sufficient resistance to the acidic aqueous solution in the acid cleaning treatment described below, whereas if the content of the non-metallic element exceeds 40 at %, then the first layer 22a will tend to become brittle and break.

The second layer 22b comprises an alloy containing one metallic element selected from the group consisting of Ni, Co and Cu, and an element having a greater ionization tendency than this metallic element. For example, the second layer 22b comprises an NiFe alloy, a CoFe alloy, a CuNi alloy or the like. As shown in FIG. 2, Fe(II) has a greater ionization tendency than Ni and Co, and hence is electrochemically baser than Ni and Co, and Ni has a greater ionization tendency than Cu, and hence is electrochemically baser than Cu. Moreover, the content of the Ni, Co or Cu in the second layer 22b is preferably at least 50 at % but less than 100 at %.

The foundation film 22 can be formed by forming the first layer 22a and the second layer 22b on the substrate 21 in this order by, for example, sputtering. To obtain good adhesion between the substrate 21 and the first layer 22a, a bonding layer (omitted from the drawings) may be provided between the substrate 21 and the first layer 22a. Moreover, to obtain good adhesion between the first layer 22a and the second layer 22b, a bonding layer (omitted from the drawings) may be provided between the first layer 22a and the second layer 22b. In the case of using Cu as the primary material of the alloy constituting the first layer 22a or the second layer 22b, for example, Ni or Co can be used as the material constituting such a bonding layer.

FIG. 5 shows the layered structure of an optical magnetic disk Y2, which is an example of a recording medium manufactured using the recording medium substrate X2. The optical magnetic disk Y2 comprises the recording medium substrate X2, a recording magnetic section 41, a soft magnetic layer 42, a pre-groove layer 43, a heat dissipating layer 44, dielectric layers 45 and 46, and a protective film 47, and is constituted as a rewritable front illumination type optical magnetic disk bearing the two functions of thermomagnetic recording and playback using a magneto-optical effect.

The recording magnetic section 41 has a magnetic structure comprising one magnetic film or a plurality of magnetic films capable of bearing the two functions of thermomagnetic recording and playback using a magneto-optical effect, and is a section in which information is recorded. The recording magnetic section 41 comprises, for example, a single recording layer having both a recording function and a playback function. Alternatively, the recording magnetic section 41 may have a two-layer structure comprising a recording layer that has a relatively high coercivity and bears a recording function, and a playback layer that has a relatively large Kerr rotation angle for a playback laser and bears a playback function. Alternatively, the recording magnetic section 41 may have a three-layer structure comprising a recording layer, a playback layer, and an intermediate layer therebetween, for realizing an MSR format, a MAMMOS format, or a DWDD format. Each of the various layers in each of the structures that can be adopted for the recording magnetic section 41 comprises an amorphous alloy between a rare earth element and a transition metal, and is a perpendicularly magnetized film that has perpendicular magnetic anisotropy and is magnetized in a perpendicular direction. Specifically, the recording layer comprises, for example, TbFeCo, DyFeCo or TbDyFeCo having a prescribed composition. In the case of providing a recording layer, the recording layer comprises, for example, GdFeCo, GdDyFeCo, GdTbDyFeCo, NdDyFeCo, NdGdFeCo or PrDyFeCo having a prescribed composition. In the case of providing an intermediate layer, the intermediate layer comprises, for example, GdFe, TbFe, GdFeCo, GdDyFeCo, GdTbDyFeCo, NdDyFeCo, NdGdFeCo or PrDyFeCo having a prescribed composition.

The soft magnetic layer 42 is an applied magnetic field enhancing layer for improving the net recording sensitivity of the recording magnetic section 41 by increasing the magnetic flux density of a magnetic field applied to the recording magnetic section 41 during recording to the optical magnetic disk Y2, and comprises a soft magnetic plating film formed by electroless plating. As the soft magnetic material for constituting the soft magnetic layer 42, for example FeCoNi, FeNi or CoNi can be used. The thickness of the soft magnetic layer 42 is, for example, 0.5 to 5 μm.

The pre-groove layer 43 comprises a resin material, and has formed in a surface thereof contacting the heat dissipating layer 44 spiral or concentric circular pre-grooves (omitted from the drawings). Based on these pre-grooves, a land-groove form is realized on the optical magnetic disk Y2. As the resin material constituting the pre-groove layer 43, for example an acrylic resin, a polycarbonate (PC) resin, an epoxy resin, or a polyolefin resin can be used.

The heat dissipating layer 44 is a portion for efficiently transmitting heat generated in the recording magnetic section 41 or the like during irradiation of a laser onto the optical magnetic disk Y2 to the recording medium substrate X2 or the substrate 21, and comprises, for example, a material having high thermal conduction such as Ag, an Ag alloy (AgPdCuSi, AgPdCu etc.), an Al alloy (AlTi, AlCr etc.), Au, or Pt.

The dielectric layers 45. and 46 are portions for preventing or suppressing magnetic influence, chemical influence and so on from the outside on the recording magnetic section 41, and comprise, for example, SiN, SiO₂, YSiO₂, ZnSiO₂, AlO, or AlN. Moreover, the dielectric layer 46 may also have a function of increasing the apparent Kerr rotation angle of reflected light at the surface of the recording magnetic section 41 on the protective film 47 side.

The protective film 47 covers the recording magnetic section 41 to protect the recording magnetic section 41 from dust and the like, and comprises a resin material having sufficient transparency to a recording laser and a playback laser.

In the optical magnetic disk Y2, because there is a soft magnetic layer 42 having a high saturation magnetization and a low coercivity close to the recording magnetic section 41, during recording the magnetic flux of a recording magnetic field applied to the recording magnetic section 41 or a recording layer contained therein from a magnetic recording head does not spread out but rather is concentrated in the recording magnetic section 41 or recording layer. The net recording sensitivity of the recording magnetic section 41 or recording layer is thus higher than in the case that such a soft magnetic layer 42 is not present. The increase in the recording sensitivity of the recording magnetic section 41 or recording layer enables a reduction in the magnetic field applied by the magnetic recording head, and this reduction in the applied magnetic field enables recording at a higher frequency, i.e. enables high-speed recording to be suitably realized. Such an increase in the recording speed is important in realizing an optical magnetic recording medium having a high recording density. Moreover, the smaller the applied magnetic field, the smaller the current required to generate the magnetic field, which is desirable in terms of reducing the power consumption during recording.

In the manufacture of the optical magnetic disk Y2, first, the soft magnetic layer 42 (soft magnetic plating film) is formed on the recording medium substrate X2 by electroless plating. Next, the pre-groove layer 43 is formed on the soft magnetic layer 42 by, for example, a so-called 2P method. Next, the heat dissipating layer 44; the dielectric layer 45, the recording magnetic section 41 and the dielectric layer 46 are formed in this order on the pre-groove layer 43 by, for example, sputtering. After that, the protective film 47 is formed on the dielectric layer 46 by, for example, spin coating.

In the formation of the soft magnetic layer 42 on the recording medium substrate X2, as described earlier with regard to the formation of the soft magnetic layer 32 on the recording medium substrate X1, acid cleaning treatment and catalyst treatment are carried out, and then the soft magnetic layer 42 (soft magnetic plating film) is grown on the foundation film 22 or on the second layer 22b. In the acid cleaning treatment, local cell reactions occur on the surface of the second layer 22b, and hence the whole of the surface of the foundation film 22 is uniformly dissolved instantaneously, and hence a new surface of the foundation film 22 on which a contaminant film does not remain at all or hardly remains is exposed.

The first layer 22a in the foundation film 22 of the recording medium substrate X2 comprises an alloy selected from the group consisting of NiP, NiB, NiC, NiS, CoP, CoB, CoC, CoS, CuP, CuB, CuC and CuS; these alloys have a considerably high resistance to the acidic aqueous solution in the acid cleaning treatment. Consequently, in the acid cleaning treatment, even if pinhole defects should happen to arise in the second layer 22b which has a relatively high activity to the acidic aqueous solution, i.e. even if pinholes that penetrate through the second layer 22b in the thickness direction thereof should happen to be formed, parts of the first layer 22a exposed by these pinholes will substantially not be dissolved by the acidic aqueous solution. As a result, in the catalyst treatment, catalytic nuclei can be adsorbed onto the surface of the first layer 22a at places facing out onto the pinholes, and hence inappropriate unevenness will not arise in the distribution of the catalytic nuclei over the surface of the foundation film 22 as a whole, and moreover the catalytic nuclei will be adsorbed at a sufficient density at each place on the surface of the foundation film 22. Because inappropriate unevenness does not arise in the distribution of the catalytic nuclei on the surface of the foundation film 22 after the catalyst treatment, and moreover the catalytic nuclei are adsorbed at a sufficient density at each place on the surface of the foundation film 22, a soft magnetic plating film will grow homogeneously and finely on the foundation film 22. Consequently, a soft magnetic layer 42 for which roughness of the growth end face is suppressed, and moreover a drop in the film density is suppressed, i.e. a soft magnetic layer 42 having a good film quality, is formed. In this way, a soft magnetic layer 42 (electroless plating film) having a good film quality can be formed on the recording medium substrate X2. The better the film quality of the soft magnetic layer 42, the more effectively the applied magnetic field enhancing function of the soft magnetic layer 42 can be displayed, which is preferable in terms of improving the recording characteristics of the optical magnetic disk Y2.

Next, various examples of the present invention will be described along with comparative examples.

### EXAMPLE 1

40 recording medium substrates of the present example were manufactured as substrates having one of the structures described earlier with regard to the recording medium substrate X1. In the manufacture of each of the recording medium substrates of the present example, Ni₈₀Fe₂₀ was deposited by sputtering on a glass disk substrate (diameter 90 mm, thickness 1.2 mm), thus forming an NiFe layer of thickness 30 nm as a foundation film. In this sputtering, an NiFe alloy target (diameter 6 inches) was used. Moreover, in the sputtering, Ar gas was used as a sputter gas, the sputter gas pressure was set to 0.5 Pa, and the electrical discharge power was set to 1.0 kW. The same sputtering conditions were also used in other examples described hereinafter. The details of the makeup of the recording medium substrates of the present example are shown in Tables 1 to 4, together with those for the other examples.

### EXAMPLE 2

40 recording medium substrates of the present example were manufactured as substrates according to the recording medium substrate X1. In the manufacture of each of the recording medium substrates of the present example, Co₈₀Fe₂₀ was deposited by sputtering on a glass disk substrate (diameter 90 mm, thickness 1.2 mm), thus forming a CoFe layer of thickness 30 nm as a foundation film. In this sputtering, a CoFe alloy target (diameter 6 inches) was used.

### EXAMPLE 3

40 recording medium substrates of the present example were manufactured as substrates according to the recording medium substrate X1. In the manufacture of each of the recording medium substrates of the present example, first Ti was deposited by sputtering on a glass disk substrate (diameter 90 mm, thickness 1.2 mm), thus forming a Ti layer of thickness 5 nm as a bonding layer. In this sputtering, a Ti target (diameter 6 inches) was used. Next, Cu₈₅Ni₁₅ was deposited by sputtering, thus forming a CuNi layer of thickness 30 nm as a foundation film. In this sputtering, a CuNi alloy target (diameter 6 inches) was used.

### EXAMPLE 4

40 recording medium substrates of the present example were manufactured as substrates having one of the structures described earlier with regard to the recording medium substrate X2. In the manufacture of each of the recording medium substrates of the present example, first Ni₈₈P₁₂ was deposited by sputtering on a glass disk substrate (diameter 90 mm, thickness 1.2 mm), thus forming an NiP layer of thickness 30 nm as a first layer of a foundation film. In this sputtering, an NiP alloy target (diameter 6 inches) was used. Next, Ni₈₀Fe₂₀ was deposited on the NiP layer by sputtering, thus forming an NiFe layer of thickness 30 nm as a second layer of the foundation film. The specific method of forming this NiFe layer was as with the method of forming the NiFe layer (the foundation film) in Example 1. In this way, a foundation film comprising an NiP layer (first layer) and an NiFe layer (second layer) was formed on each glass disk substrate.

### EXAMPLE 5

40 recording medium substrates of the present example were manufactured as substrates according to the recording medium substrate X2. In the manufacture of each of the recording medium substrates of the present example, first, as in Example 4, an NiP layer (first layer) of thickness 30 nm was formed on a glass disk substrate by sputtering. Next, Co₈₀Fe₂₀ was deposited on the NiP layer by sputtering, thus forming a CoFe layer of thickness 30 nm as the second layer of the foundation film. The specific method of forming this CoFe layer was as with the method of forming the CoFe layer (the foundation film) in Example 2. In this way, a foundation film comprising an NiP layer (first layer) and a CoFe layer (second layer) was formed on each glass disk substrate.

### EXAMPLE 6

40 recording medium substrates of the present example were manufactured as substrates according to the recording medium substrate X2. In the manufacture of each of the recording medium substrates of the present example, first, as in Example 4, an NiP layer (first layer) of thickness 30 nm was formed on a glass disk substrate by sputtering. Next, Ni was deposited on the NiP layer by sputtering, thus forming an Ni layer of thickness 5 nm as a bonding layer. Next, Cu₈₅Ni₁₅ was deposited on the Ni layer by sputtering, thus forming a CuNi layer of thickness 30 nm as the second layer of the foundation film. The specific method of forming the Ni layer and the CuNi layer in this example was as with the method of forming the Ti layer (the bonding layer) and the CuNi layer (the foundation film) in Example 3 except that an Ni target was used in place of the Ti target in forming the Ni layer. In this way, a foundation film comprising an NiP layer (first layer), an Ni layer (bonding layer) and a CuNi layer (second layer) was formed on each glass disk substrate.

### EXAMPLE 7

20 recording medium substrates of the present example were manufactured as in Example 4, except that an NiB layer (thickness 30 nm) was formed instead of the NiP layer as the first layer. In the formation of the NiB layer, Ni₈₅B₁₅ was deposited on each glass disk substrate by sputtering. In this sputtering, a composite target comprising an Ni target (diameter 6 inches) having 12 B chips (10 mm square) placed thereon was used. Each of the recording medium substrates of the present example had a foundation film comprising an NiB layer (first layer) and an NiFe layer (second layer) on the glass disk substrate. The details of the layered structure of the recording medium substrates of the present example are shown in Table 4, together with those for Examples 8 to 17 described below.

### EXAMPLE 8

20 recording medium substrates of the present example were manufactured as in Example 4, except that an NiC layer (thickness 30 nm) was formed instead of the NiP layer as the first layer. In the formation of the NiC layer, Ni₈₅C₁₅ was deposited on each glass disk substrate by sputtering. In this sputtering, a composite target comprising an Ni target (diameter 6 inches) having 12 C chips (10 mm square) placed thereon was used. Each of the recording medium substrates of the present example had a foundation film comprising an NiC layer (first layer) and an NiFe layer (second layer) on the glass disk substrate.

### EXAMPLE 9

20 recording medium substrates of the present example were manufactured as in Example 4, except that an NiS layer (thickness 30 nm) was formed instead of the NiP layer as the first layer. In the formation of the NiS layer, Ni₈₈S₁₂ was deposited on each glass disk substrate by sputtering. In this sputtering, an NiS alloy target was used. Each of the recording medium substrates of the present example had a foundation film comprising an NiS layer (first layer) and an NiFe layer (second layer) on the glass disk substrate.

### EXAMPLE 10

20 recording medium substrates of the present example were manufactured as in Example 4, except that a CoP layer (thickness 30 nm) was formed instead of the NiP layer as the first layer. In the formation of the CoP layer, Co₉₀P₁₀ was deposited on each glass disk substrate by sputtering. In this sputtering, a CoP alloy target (diameter 6 inches) was used. Each of the recording medium substrates of the present example had a foundation film comprising a CoP layer (first layer) and an NiFe layer (second layer) on the glass disk substrate.

### EXAMPLE 11

20 recording medium substrates of the present example were manufactured as in Example 4, except that a CoB layer (thickness 30 nm) was formed instead of the NiP layer as the first layer. In the formation of the CoB layer, C0₈₅B₁₅ was deposited on each glass disk substrate by sputtering. In this sputtering, a composite target comprising a Co target (diameter 6 inches) having 12 B chips (10 mm square) placed thereon was used. Each of the recording medium substrates of the present example had a foundation film comprising a CoB layer (first layer) and an NiFe layer (second layer) on the glass disk substrate.

### EXAMPLE 12

20 recording medium substrates of the present example were manufactured as in Example 4, except that a CoC layer (thickness 30 nm) was formed instead of the NiP layer as the first layer. In the formation of the CoC layer, C0₈₅C₁₅ was deposited on each glass disk substrate by sputtering. In this sputtering, a composite target comprising a Co target (diameter 6 inches) having 12 C chips (10 mm square) placed thereon was used. Each of the recording medium substrates of the present example had a foundation film comprising a CoC layer (first layer) and an NiFe layer (second layer) on the glass disk substrate.

### EXAMPLE 13

20 recording medium substrates of the present example were manufactured as in Example 4, except that a CoS layer (thickness 30 nm) was formed instead of the NiP layer as the first layer. In the formation of the CoS layer, Co₉₀S₁₀ was deposited on each glass disk substrate by sputtering. In this sputtering, a CoS alloy target (diameter 6 inches) was used. Each of the recording medium substrates of the present example had a foundation film comprising a CoS layer (first layer) and an NiFe layer (second layer) on the glass disk substrate.

### EXAMPLE 14

20 recording medium substrates of the present example were manufactured as in Example 4, except that a CuP layer (thickness 30 nm) was formed instead of the NiP layer as the first layer. In the formation of the CuP layer, Cu₈₈P₁₂ was deposited on each glass disk substrate by sputtering. In this sputtering, a CuP alloy target (diameter 6 inches) was used. Each of the recording medium substrates of the present example had a foundation film comprising a CuP layer (first layer) and an NiFe layer (second layer) on the glass disk substrate.

### EXAMPLE 15

20 recording medium substrates of the present example were manufactured as in Example 4, except that a CuB layer (thickness 30 nm) was formed instead of the NiP layer as the first layer. In the formation of the CuB layer, Cu₉₀B₁₀ was deposited on each glass disk substrate by sputtering. In this sputtering, a composite target comprising a Cu target (diameter 6 inches) having 12 B chips (10 mm square) placed thereon was used. Each of the recording medium substrates of the present example had a foundation film comprising a CuB layer (first layer) and an NiFe layer (second layer) on the glass disk substrate.

### EXAMPLE 16

20 recording medium substrates of the present example were manufactured as in Example 4, except that a CuC layer (thickness 30 nm) was formed instead of the NiP layer as the first layer. In the formation of the CuC layer, Cu₉₀C₁₀ was deposited on each glass disk substrate by sputtering. In this sputtering, a composite target comprising a Cu target (diameter 6 inches) having 12 C chips (10 mm square) placed thereon was used. Each of the recording medium substrates of the present example had a foundation film comprising a CuC layer (first layer) and an NiFe layer (second layer) on the glass disk substrate.

### EXAMPLE 17

20 recording medium substrates of the present example were manufactured as in Example 4, except that a CuS layer (thickness 30 nm) was formed instead of the NiP layer as the first layer. In the formation of the CuS layer, Cu₈₈S₁₂ was deposited on each glass disk substrate by sputtering. In this sputtering, a CuS alloy target (diameter 6 inches) was used. Each of the recording medium substrates of the present example had a foundation film comprising a CuS layer (first layer) and an NiFe layer (second layer) on the glass disk substrate.

### COMPARATIVE EXAMPLE 1

40 recording medium substrates of the present comparative example were manufactured as in Example 1, except that an NiP layer (thickness 30 nm) was formed instead of the NiFe layer as the foundation film. In the formation of the NiP layer, as in the formation of the NiP layer in Example 4, Ni₈₈P₁₂ was deposited on each glass disk substrate by sputtering. The details of the makeup of the recording medium substrates of this comparative example are shown in Tables 1-3, together with those for Comparative Examples 2 and 3.

### COMPARATIVE EXAMPLE 2

40 recording medium substrates of the present comparative example were manufactured as in Example 1, except that a CoP layer (thickness 30 nm) was formed instead of the NiFe layer as the foundation film. In the formation of the CoP layer, as in the formation of the CoP layer in Example 10, Co₉₀P₁₀ was deposited on each glass disk substrate by sputtering.

### COMPARATIVE EXAMPLE 3

40 recording medium substrates of the present comparative example were manufactured as in Example 1, except that instead of the NiFe layer, there were formed a Ti layer (thickness 5 nm) as a bonding layer and a CuPt layer (thickness 30 nm) as a foundation film thereon. The specific method of forming the Ti layer was as with the method of forming the Ti layer in Example 3. In the formation of the CuPt layer, Cu₈₅Pt₁₅ was deposited on the Ti layer (bonding layer) by sputtering. In this sputtering, a CuPt alloy target (diameter 6 inches) was used.

[Formation of Electroless Plating Film]

An electroless plating film was formed by electroless plating on the foundation film of each of the recording medium substrates of Examples 1 to 17 and Comparative Examples 1 to 3. For 20 of the recording medium substrates of each of Examples 1 to 6 and Comparative Examples 1 to 3, an electroless plating film of thickness 300 nm was formed, and for the other 20 of the recording medium substrates of each of Examples 1 to 6 and Comparative Examples 1 to 3, and the 20 recording medium substrates of each of Examples 7 to 17, an electroless plating film of thickness 1000 nm was formed.

In the formation of the electroless plating film on the foundation film of each of the recording medium substrates, first the surface of the foundation film of the recording medium substrate was subjected to acid cleaning treatment. Specifically, the recording medium substrate was immersed for 15 to 30 seconds in 5 vol % hydrochloric acid (room temperature) as an acidic aqueous solution. Next, the recording medium substrate was washed for 30 to 60 seconds with running water at room temperature. Next, the surface of the foundation film of the recording medium substrate was subjected to catalyst treatment. Specifically, the recording medium substrate was immersed for 15 to 30 seconds in a 0.25 g/dm³ palladium chloride aqueous solution (room temperature) as a catalyst solution. Next, the recording medium substrate was washed for 30 to 60 seconds with running water at room temperature. Next, a CoFeNi film (electroless plating film) was grown on the foundation film. Specifically, the recording medium substrate was immersed for 5 minutes (thickness 300 nm) or 15 minutes (thickness 1000 nm) in an electroless plating liquid (65° C., pH 9). The electroless plating liquid used contained 0.025 mol/dm³ of dimethylamine borane (DMAB), 0.05 mol/dm³ of trisodium citrate, 0.20 mol/dm³ of sodium tartrate, 0.20 mol/dm³ of ammonium sulfate, 0.06 mol/dm³ of phosphorous acid, 0.01 mol/dm³ of iron sulfate, 0.01 mol/dm³ of nickel sulfate, and 0.09 mol/dm³ of cobalt sulfate. Such CoFeNi is a soft magnetic material. Next, the electroless plating film-possessing recording medium substrate was washed for 60 to 120 seconds with running water at room temperature. After that, the substrate was dried. In this way, a CoFeNi film (electroless plating film) was formed on the foundation film of each recording medium substrate.

[Surface Observations]

For the electroless plating film formed on each of the total of 360 recording medium substrates of Examples 1 to 6 and Comparative Examples 1 to 3, the state of cloudiness of the film surface was investigated by visual observation. The results are shown in Table 1. The more uniform the growth of the plating film, and the finer the growth of the plating film (i.e. the finer the state of orientation of the plating particles constituting the plating film), the lower the roughness of the surface of the plating film, and hence the less prone the surface of the plating film is to becoming cloudy. On the other hand, the less uniform the growth of the plating film, and the coarser the growth of the plating film (i.e. the coarser the state of orientation of the plating particles constituting the plating film), the greater the roughness of the surface of the plating film, and hence the more prone the surface of the plating film is to becoming cloudy. The presence/absence of cloudiness and the extent thereof can thus be used as an indicator in judging the extent of roughness of the surface of the plating film and the film quality of the plating film.

For all of the recording medium substrates of Comparative Examples 1 and 2, the electroless plating film was partially cloudy. That is, for these electroless plating films, there were found to be cloudy places on the surface. On the other hand, for 5 recording medium substrates out of the recording medium substrates of Comparative Example 3 having an electroless plating film of thickness 300 nm formed thereon, the electroless plating film was partially cloudy, and for 17 recording medium substrates out of the recording medium substrates of Comparative Example 3 having an electroless plating film of thickness 1000 nm formed thereon, the electroless plating film was partially cloudy. Moreover, for the recording medium substrates of Comparative Examples 1 to 3, the extent of the cloudiness tended to be higher for an electroless plating film thickness of 1000 nm than 300 nm. The reason that such a difference arises in the extent of cloudiness upon a difference in the thickness of the electroless plating film, or as seen for the recording medium substrates of Comparative Example 3, a difference arises in the tendency for cloudiness to occur upon a difference in the thickness of the electroless plating film, is that the thicker the electroless plating film, the greater the particle diameter of coarse particles occurring in the electroless plating film, and hence the rougher the film surface.

In contrast with the above, for all of the recording medium substrates of Examples 1 to 6, there were no cloudy places on the surface of the electroless plating film, regardless of whether the thickness of the electroless plating film was 300 nm or 1000 nm. From the above, it can be seen that an electroless plating film having lower surface roughness can be formed for the recording medium substrates of Examples 1 to 6 according to the present invention than for the recording medium substrates of Comparative Examples 1 to 3. In addition, it can be seen that for the recording medium substrates of Examples 1 to 6, even if the thickness of the electroless plating film is high at 1000 nm, an electroless plating film having low surface roughness can be formed.

[Cut Cross Section SEM Observations]

For the electroless plating film formed on each of the total of 360 recording medium substrates of Examples 1 to 6 and Comparative Examples 1 to 3, a cut cross section was observed using a scanning electron microscope (SEM). The results are shown in Table 2. The film structure of the electroless plating film formed on all of the recording medium substrates of Examples 1 to 6 was minute and fine. On the other hand, for the electroless plating film formed on all of the recording medium substrates of Comparative Examples 1 to 3, coarse particles were present, the particle diameter of the coarse particles tending to be greater for an electroless plating film thickness of 1000 nm than 300 nm. The presence of coarse particles in the plating film is caused by the palladium catalytic nuclei being adsorbed unevenly on the surface of the foundation film in the catalyst treatment during the process of forming the electroless plating film by electroless plating. From the above, it can be seen that an electroless plating film having a minute, fine film structure can be formed more readily for the recording medium substrates of Examples 1 to 6 according to the present invention than for the recording medium substrates of Comparative Examples 1 to 3.

[Saturation Magnetic Flux Density Measurements]

For the electroless plating film formed on each of the total of 360 recording medium substrates of Examples 1 to 6 and Comparative Examples 1 to 3, the saturation magnetic flux density was measured using a vibrating sample magnetometer (VSM). The results are shown in Table 3. The coarser the film quality of the plating film (i.e. the lower the film density of the plating film), the greater the apparent volume (=film area×film thickness) of the plating film compared with the effective volume of the plating film, and hence in the case of calculating the saturation magnetic flux density from ‘measured magnetization÷apparent volume’, the smaller the value of the saturation magnetic flux density. The value of the saturation magnetic flux density (=measured magnetization÷apparent volume) can thus be used as an indicator of the film density of the plating film.

All of the electroless plating films formed on the recording medium substrates of Examples 1 to 6 exhibited a relatively high saturation magnetic flux density. On the other hand, all of the electroless plating films formed on the recording medium substrates of Comparative Examples 1 to 3 exhibited a relatively low saturation magnetic flux density. Moreover, the 300 nm-thick electroless plating films formed on the recording medium substrates of Comparative Examples 1 to 3 exhibited a lower saturation magnetic flux density than the 1000 nm-thick electroless plating films formed on the recording medium substrates of Comparative Examples 1 to 3. This is because the film structure of the electroless plating film at the plating growth start end and close thereto is prone to being coarse. From the above, it can be seen that an electroless plating film having a finer film structure and a higher film density can be formed for the recording medium substrates of Examples 1 to 6 according to the present invention than for the recording medium substrates of Comparative Examples 1 to 3. In addition, it can be seen that for the recording medium substrates of Examples 1 to 6, even if the thickness of the electroless plating film is low at 300 nm, an electroless plating film having a fine film structure and a high film density can be formed.

[Counting of Number of Pinhole Defects]

For the electroless plating film formed on each of the 20 recording medium substrates of each of Examples 1 to 17, the number of pinhole defects was counted by visual observation, and for each of the Examples, the mean number of pinhole defects arising in the electroless plating film on a single recording medium substrate was calculated. The results are shown in Table 4. Pinhole defects in the plating film arise in the case that pinholes have been formed in the foundation film, and hence the lower the number of pinholes formed in the foundation film, the lower the number of pinhole defects in the plating film formed on the foundation film.

Pinhole defects were less prone to arising in the electroless plating films formed on the recording medium substrates of Examples 4 to 17 than the electroless plating films formed on the recording medium substrates of Examples 1 to 3. The first layer in the foundation film of the recording medium substrate of each of Examples 4 to 17 comprises NiP, NiB, NiC, NiS, CoP, CoB, CoC, CoS, CuP, CuB, CuC or CuS, and these alloys have a considerably high resistance to the acidic aqueous solution in the acid cleaning treatment. Consequently, in the acid cleaning treatment, even if pinholes that penetrate through the second layer are formed in the second layer which has a relatively high activity to the acidic aqueous solution, parts of the first layer exposed by these pinholes will substantially not be dissolved by the acidic aqueous solution. That is, due to the presence of the first layer, pinholes that penetrate through the foundation film are suppressed from arising. It is thought that in the catalyst treatment, catalytic nuclei can also be adsorbed onto the surface of the first layer at places facing out onto pinholes penetrating through the second layer, whereby the formation of pinholes in the electroless plating film, which grows with the catalytic nuclei acting as base points, is suppressed. From the above, it can be seen that according to the recording medium substrates of Examples 4 to 17 having a foundation film having a multi-layer structure (a first layer and a second layer), an electroless plating film having few pinhole defects can be formed.

The present invention being thus described, it is obvious that the same may be varied in many ways. Such variations should be regarded as a departure from the spirit and scope of the present invention, and all such medications as would be obvious to those skilled in the art are intended to be included within the scope of the appended claims.

TABLE 1
SURFACE OBSERVATIONS ON ELECTROLESS PLATING FILMS
ON RECORDING MEDIUM SUBSTRATES OF EXAMPLES 1 TO 6
AND COMPARATIVE EXAMPLES 1 TO 3

| | | OBSERVATION RESULTS | |
|---|---|---|---|
| RECORDING | MAKEUP OF | PLATING FILM | PLATING FILM |
| MEDIUM | FOUNDA- | THICKNESS | THICKNESS |
| SUBSTRATE | TION FILM | 300 nm | 1000 nm |
| EXAMPLE 1 | NiFe | NO | NO |
| | | CLOUDINESS | CLOUDINESS |
| EXAMPLE 2 | CoFe | NO | NO |
| | | CLOUDINESS | CLOUDINESS |
| EXAMPLE 3 | Ti/CuNi | NO | NO |
| | | CLOUDINESS | CLOUDINESS |
| EXAMPLE 4 | NiP/NiFe | NO | NO |
| | | CLOUDINESS | CLOUDINESS |
| EXAMPLE 5 | NiP/CoFe | NO | NO |
| | | CLOUDINESS | CLOUDINESS |
| EXAMPLE 6 | NiP/Ni/CuNi | NO | NO |
| | | CLOUDINESS | CLOUDINESS |
| COMPARATIVE | NiP | PARTIALLY | PARTIALLY |
| EXAMPLE 1 | | CLOUDY | CLOUDY |
| | | (20/20) | (20/20) |
| COMPARATIVE | CoP | PARTIALLY | PARTIALLY |
| EXAMPLE 2 | | CLOUDY | CLOUDY |
| | | (20/20) | (20/20) |
| COMPARATIVE | Ti/CuPt | PARTIALLY | PARTIALLY |
| EXAMPLE 3 | | CLOUDY | CLOUDY |
| | | (5/20) | (17/20) |

TABLE 2
CUT CROSS SECTION SEM OBSERVATIONS ON ELECTROLESS
PLATING FILMS ON RECORDING MEDIUM SUBSTRATES OF
EXAMPLES 1 TO 6 AND COMPARATIVE EXAMPLES 1 TO 3

| | | OBSERVATION RESULTS | |
|---|---|---|---|
| RECORDING | MAKEUP OF | PLATING FILM | PLATING FILM |
| MEDIUM | FOUNDA- | THICKNESS | THICKNESS |
| SUBSTRATE | TION FILM | 300 nm | 1000 nm |
| EXAMPLE 1 | NiFe | MINUTE, FINE | MINUTE, FINE |
| | | FILM | FILM |
| | | STRUCTURE | STRUCTURE |
| EXAMPLE 2 | CoFe | MINUTE, FINE | MINUTE, FINE |
| | | FILM | FILM |
| | | STRUCTURE | STRUCTURE |
| EXAMPLE 3 | Ti/CuNi | MINUTE, FINE | MINUTE, FINE |
| | | FILM | FILM |
| | | STRUCTURE | STRUCTURE |
| EXAMPLE 4 | NiP/NiFe | MINUTE, FINE | MINUTE, FINE |
| | | FILM | FILM |
| | | STRUCTURE | STRUCTURE |
| EXAMPLE 5 | NiP/CoFe | MINUTE, FINE | MINUTE, FINE |
| | | FILM | FILM |
| | | STRUCTURE | STRUCTURE |
| EXAMPLE 6 | NiP/Ni/CuNi | MINUTE, FINE | MINUTE, FINE |
| | | FILM | FILM |
| | | STRUCTURE | STRUCTURE |
| COMPARATIVE | NiP | COARSE | COARSE |
| EXAMPLE 1 | | PARTICLES | PARTICLES |
| | | PRESENT | PRESENT |
| COMPARATIVE | CoP | COARSE | COARSE |
| EXAMPLE 2 | | PARTICLES | PARTICLES |
| | | PRESENT | PRESENT |
| COMPARATIVE | Ti/CuPt | COARSE | COARSE |
| EXAMPLE 3 | PARTICLES | PARTICLES | |
| | | PRESENT | PRESENT |

TABLE 3
SATURATION MAGNETIC FLUX DENSITIES FOR ELEC-
TROLESS PLATING FILMS ON RECORDING MEDIUM SUB-
STRATES OF EXAMPLES 1 TO 6 AND COMPARATIVE EXAM-
PLES 1 TO 3

| | | SATURATION MAGNETIC FLUX | |
|---|---|---|---|
| | | DENSITY (kGauss) | |
| RECORDING | MAKEUP OF | PLATING FILM | PLATING FILM |
| MEDIUM | FOUNDA- | THICKNESS | THICKNESS |
| SUBSTRATE | TION FILM | 300 nm | 1000 nm |
| EXAMPLE 1 | NiFe | 17 | 17 |
| EXAMPLE 2 | CaFe | 17 | 17 |
| EXAMPLE 3 | Ti/CuNi | 17 | 17 |
| EXAMPLE 4 | NiP/NiFe | 17 | 17 |
| EXAMPLE 5 | NiP/CaFe | 17 | 17 |
| EXAMPLE 6 | NiP/Ni/CuNi | 17 | 17 |
| COMPARATIVE | NiP | 12-13 | 16 |
| EXAMPLE 1 | | | |
| COMPARATIVE | CoP | 12-13 | 16 |
| EXAMPLE 2 | | | |
| COMPARATIVE | Ti/CuPt | 12-13 | 16 |
| EXAMPLE 3 | | | |

TABLE 4
NUMBER OF PINHOLE DEFECTS IN ELECTROLESS PLATING
FILMS ON RECORDING MEDIUM SUBSTRATES OF EXAMPLES
1 TO 17

| | | MEAN NUMBER OF | |
|---|---|---|---|
| | | PINHOLE DEFECTS | |
| RECORDING | MAKEUP OF | PLATING FILM | PLATING FILM |
| MEDIUM | FOUNDATION | THICKNESS | THICKNESS |
| SUBSTRATE | FILM | 300 nm | 1000 nm |
| EXAMPLE 1 | NiFe | 17.0 | 15.6 |
| EXAMPLE 2 | CaFe | 15.8 | 16.2 |
| EXAMPLE 3 | Ti/CuNi | 15.0 | 14.6 |
| EXAMPLE 4 | NiP/NiFe | 2.0 | 2.1 |
| EXAMPLE 5 | NiP/CaFe | 2.1 | 2.0 |
| EXAMPLE 6 | NiP/Ni/CuNi | 2.1 | 2.4 |
| EXAMPLE 7 | NiB/NiFe | — | 1.9 |
| EXAMPLE 8 | NiC/NiFe | — | 1.9 |
| EXAMPLE 9 | NiS/NiFe | — | 2.2 |
| EXAMPLE 10 | CaP/NiFe | — | 1.9 |
| EXAMPLE 11 | CQB/NiFe | — | 2.0 |
| EXAMPLE 12 | COC/NiFe | — | 2.5 |
| EXAMPLE 13 | CaS/NiFe | — | 2.0 |
| EXAMPLE 14 | CuP/NiFe | — | 2.2 |
| EXAMPLE 15 | CuB/NiFe | — | 2.1 |
| EXAMPLE 16 | CuC/NiFe | — | 2.4 |
| EXAMPLE 17 | CuS/NiFe | — | 2.4 |

What is claimed is:

1. A recording medium substrate having a foundation film for electroless plating film formation on a surface thereof;
wherein the foundation film comprises an alloy containing one metallic element selected from Co and Cu, and an element having a greater ionization tendency than the metallic element.

2. The recording medium substrate according to claim 1, wherein the content of the metallic element in the alloy is at least 50 at % but less than 100 at %.

3. A recording medium substrate having a foundation film, and an electroless plating film formed on the foundation film;
wherein the foundation film comprises an alloy containing one metallic element selected from Co and Cu, and an element having a greater ionization tendency than the metallic element.

4. The recording medium substrate according to claim 3, wherein the content of the metallic element in the alloy is at least 50 at % but less than 100 at %.

5. A recording medium having a layered structure comprising a foundation film, an electroless plating film formed on the foundation film, and a recording layer;
wherein the foundation film comprises an alloy containing one metallic element selected from Co and Cu, and an element having a greater ionization tendency than the metallic element.

6. The recording medium according to claim 5, wherein the content of the metallic element in the alloy is at least 50 at % but less than 100 at %.

7. A recording medium substrate having a foundation film for electroless plating film formation on a surface thereof;
wherein the foundation film comprises a first layer, and a second layer on the first layer;
wherein the first layer comprises an alloy containing a metallic element selected from the group consisting of Ni, Co and Cu, and a non-metallic element selected from the group consisting of P, B, C and S; and
wherein the second layer comprises an alloy containing one metallic element selected from the group consisting of Ni, Co and Cu, and an element having a greater ionization tendency than the metallic element.

8. The recording medium substrate according to claim 7, wherein the content of the metallic element in the alloy of the second layer is at least 50 at % but less than 100 at %.

9. A recording medium substrate having a foundation film, and an electroless plating film formed on the foundation film;
wherein the foundation film comprises a first layer, and a second layer on the first layer;
wherein the first layer comprises an alloy containing a metallic element selected from the group consisting of Ni, Co and Cu, and a non-metallic element selected from the group consisting of P, B, C and S; and
wherein the second layer comprises an alloy containing one metallic element selected from the group consisting of Ni, Co and Cu, and an element having a greater ionization tendency than the metallic element.

10. The recording medium substrate according to claim 9, wherein the content of the metallic element in the alloy of the second layer is at least 50 at % but less than 100 at %.

11. A recording medium having a layered structure comprising a foundation film, an electroless plating film formed on the foundation film, and a recording layer;
wherein the foundation film comprises a first layer, and a second layer on the first layer;
wherein the first layer comprises an alloy containing a metallic element selected from the group consisting of Ni, Co and Cu, and a non-metallic element selected from the group consisting of P, B, C and S; and
wherein the second layer comprises an alloy containing one metallic element selected from the group consisting of Ni, Co and Cu, and an element having a greater ionization tendency than the metallic element.

12. The recording medium substrate according to claim 11, wherein the content of the metallic element in the alloy of the second layer is at least 50 at % but less than 100 at %.
